(19) United States
(12) Patent Application Publication
(10) Pub. No.: US 2008/0256458 A1
(43) Pub. Date: Oct. 16, 2008

(54) Data Access Control System for Shared Directories and Other Resources

(75) Inventors: Terrence Aldred, Pottstown, PA (US); Bruce Lingenfelter, Coatesville, PA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Solutions USA, Inc., Malvern, PA (US)

(21) Appl. No.: 12/051,076

(22) Filed: Mar. 19, 2008

Related U.S. Application Data
(60) Provisional application No. 60/909,501, filed on Apr. 2, 2007.

(51) Int. Cl. G06F 3/00; G06F 15/16

(52) U.S. Cl. 715/741; 715/752; 715/772

(57) ABSTRACT

A system manages directory access permissions without help-desk intervention. The system automatically manages user permissions to access processing system resources and includes a user interface providing data representing at least one display image enabling a user to request permission to access a particular processing system resource. A communication processor, in response to detection of a user request for permission to access a particular processing system resource, automatically, acquires a user identifier and user email address, determines an owner responsible for granting permission to access the particular processing system resource and an associated owner email address, emails a request message to the owner email address to grant the access of the user to the particular processing system resource and receives a response email message indicating grant of the access. An access manager, in response to a received grant of the access and updates access data to enable the user to access the particular processing system resource.

This is a non-provisional application of provisional application Ser. No. 60/909,501 filed Apr. 2, 2007, by T. Aldred et al.

### FIELD OF THE INVENTION

This invention concerns a system for automatically managing user permissions to access processing system resources involving processing email request and response messages concerning grant of access of a user to processing system resources.

### BACKGROUND OF THE INVENTION

A substantial amount of personnel and computer resource time in organizations is typically spent managing user access to data directories or shared directories. Manual effort is involved in managing access to often thousands (literally) of network shared directories in organizations. In a typical known system a user contacts a help desk, the help desk contacts the shared directories owner to determine whether the user is allowed access to particular shared directories and if so, allocates permission to a user entitlement record granting access. The Help desk contacts the user with the news that permission was established (or denied). The Help desk fails to prompt a user for shared directories no longer needed. Known systems are largely manually operated and involve substantial worker time in manual data entry that is prone to error. These systems also typically have limited functionality and involve manually determining if a user is to be given permission to access a resource, manually allocating a user permission and manually tracking, using a spreadsheet, those users who have been allocated access to resources. Known systems also involve manual periodic review of a user community to remove unneeded user permissions. A system according to invention principles addresses these deficiencies and related problems.

### SUMMARY OF THE INVENTION

A system manages directory access permissions without help-desk intervention by automatically, prompting a user to select network shared directories from an automatically populated list of available network shared directories presented on a web page, sending the owner of the shared directories an e-mail requesting directory access approval and in response, automatically granting or denying approval and emailing a user to indicate the result of a request. A system automatically manages user permissions to access processing system resources and includes a user interface providing data representing at least one display image enabling a user to request permission to access a particular processing system resource. A communication processor, in response to detection of a user request for permission to access a particular processing system resource, automatically, acquires a user identifier and user email address, determines an owner responsible for granting permission to access the particular processing system resource and an associated owner email address, emails a request message to the owner email address to grant the access of the user to the particular processing system resource and receives a response email message indicating grant of the access. An access manager, in response to a received grant of the access and updates access data to enable the user to access the particular processing system resource.

### BRIEF DESCRIPTION OF THE DRAWING

FIG. 1 shows a system for automatically managing user permissions to access processing system resources, according to invention principles.

FIG. 2 shows a flowchart of a process for automatically managing user permissions to access processing system resources, according to invention principles.

FIGS. 3 and 4 show user interface display image windows enabling a user to initiate a request for permission to access a processing system resource, according to invention principles.

FIGS. 5 and 6 illustrate user interface display image windows enabling a user to select processing system resources to access that are available on one or more servers, according to invention principles.

FIG. 7 shows a message communicated to a user indicating a request for access to a processing system resource is pending, according to invention principles.

FIGS. 8 and 9 show user interface display images enabling a recipient of a request for access to a processing system resource to grant access, according to invention principles.

FIG. 10 shows a flowchart of a process performed by a system for monitoring periodic processing of business related data to provide reports at day end and other times, according to invention principles.

### DETAILED DESCRIPTION OF THE INVENTION

A large amount of resource time in middle to large size companies is spent managing user access to data directories or shared directories. A system manages directory access permissions without help-desk intervention by automatically, prompting a user to select network shared directories from an automatically populated list of available network shared directories presented on a web page, sending the owner of the shared directories an e-mail requesting directory access approval and in response, automatically granting or denying access to a user and emailing the user to indicate the result. Network shared directories comprise data storage that exists on central servers or workstations, that can be accessed by a plurality of users as long as the user has the authority. If approval is granted, a user receives an e-mail and the system automatically adds data identifying the user to an authorizations list indicating users authorized to access a directory. The system further, prompts the user to review a list of shared directories to which they have access and to relinquish access to those shared directories that is no longer needed.

A group as used herein, is an object holding user identifiers. A group containing a user identifier indicates the user has authority to access specific processing system resources such as printers, file directories, disk drives, peripherals, communication interfaces, memory, applications and other resources. Directories on disk drives attached to servers, available on a network, may be termed shared directories or folders. A shared directory (may be termed a share) and may comprise a folder or file. A processor, as used herein, operates under the control of an executable application to (a) receive information from an input information device, (b) process the information by manipulating, analyzing, modifying, converting and/or transmitting the information, and/or (c) route the information to an output information device. A processor may use, or comprise the capabilities of, a controller or microprocessor, for example. The processor may operate with a display processor or generator. A display processor or generator is a known element for generating signals representing display images or portions thereof. A processor and a display processor may comprise a combination of, hardware, firmware, and/or software.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters. A user interface (UI), as used herein, comprises one or more display images, generated by a display processor and enabling user interaction with a processor or other device and associated data acquisition and processing functions.

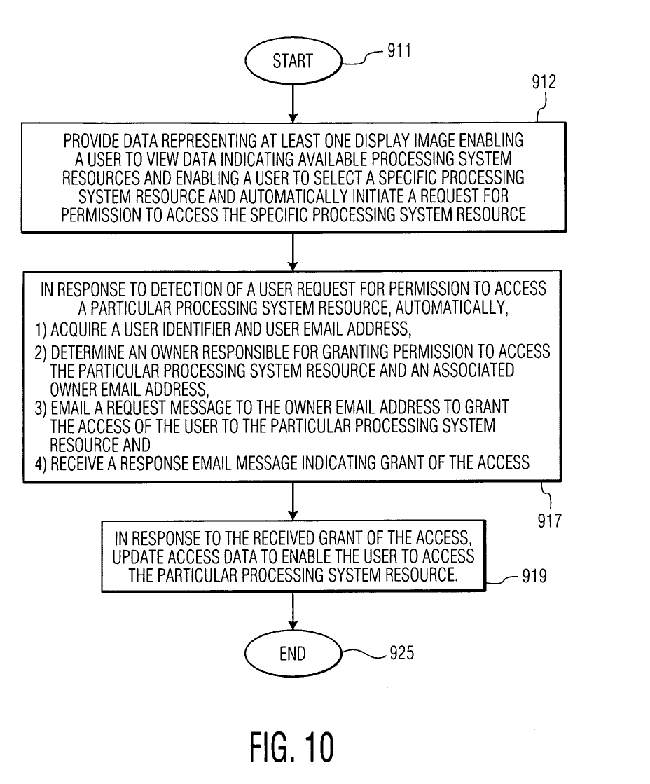

The UI also includes an executable procedure or executable application. The executable procedure or executable application conditions the display processor to generate signals representing the UI display images. These signals are supplied to a display device which displays the image for viewing by the user. The executable procedure or executable application further receives signals from user input devices, such as a keyboard, mouse, light pen, touch screen or any other means allowing a user to provide data to a processor. The processor, under control of an executable procedure or executable application, manipulates the UI display images in response to signals received from the input devices. In this way, the user interacts with the display image using the input devices, enabling user interaction with the processor or other device. The functions and process steps (e.g., of FIG. 10) herein may be performed automatically or wholly or partially in response to user command. An activity (including a step) performed automatically is performed in response to executable instruction or device operation without user direct initiation of the activity.

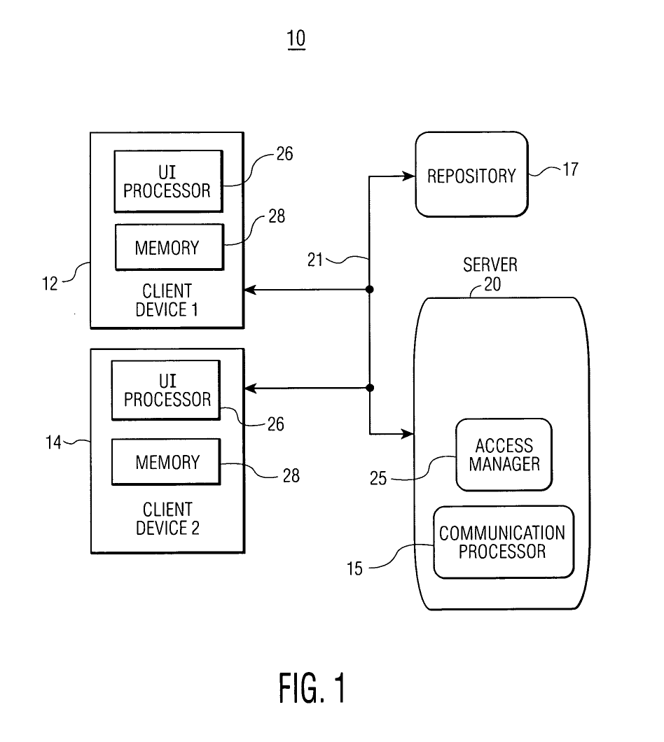

FIG. 1 shows system 10 for automatically managing user permissions to access processing system resources. System 10 includes client devices (e.g. workstations, Personal Digital Assistants, cell phones) 12 and 14, at least one repository 17 and server 20 inter-communicating via network 21. Server 20 includes communication processor 15 and access manager 25. Client devices 12 and 14 individually include memory 28 and user interface 26. User interface 26 provides data representing display images for presentation on client device 12 and 14. Specifically user interface 26 provides data representing one or more display images enabling a user to request permission to access a particular processing system resource. Communication processor 15, in response to detection of a user request for permission to access a particular processing system resource, automatically, acquires data comprising a user identifier and user email address. Processor 15 determines an owner responsible for granting permission to access the particular processing system resource and an associated owner email address, emails a request message to the owner email address to grant the access of the user to the particular processing system resource and receives a response email message indicating grant of the access. Access manager 25, in response to received data indicating a grant of access, updates access data to enable the user to access the particular processing system resource. In one embodiment, access manager 25 includes a resource manager system responsible for automatically managing access to processing system resources.

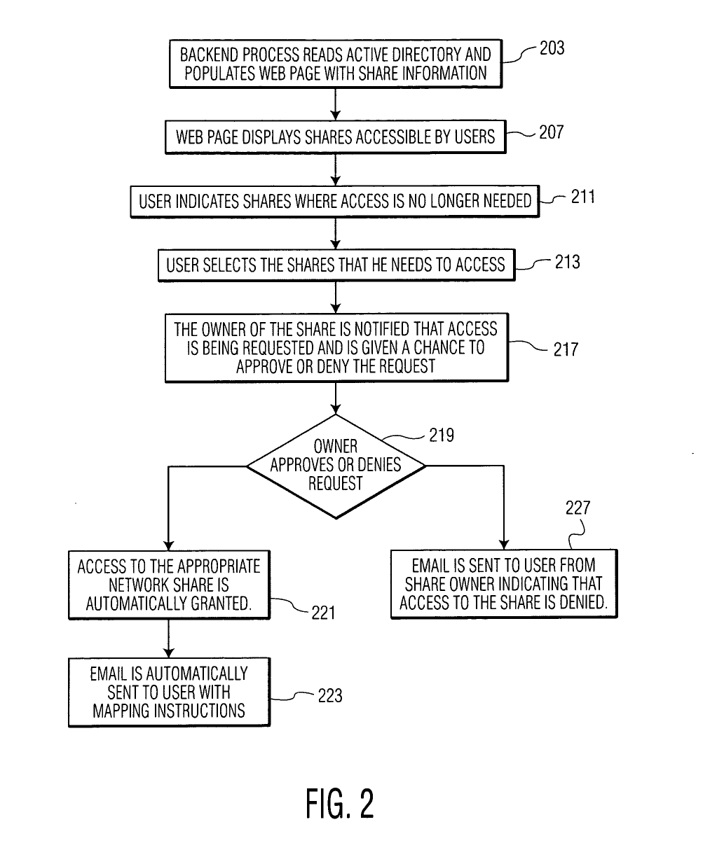

FIG. 2 shows a flowchart of a process employed by system 10 for automatically managing user permissions to access processing system resources. The steps of FIG. 2 are performed automatically or in another embodiment partially automatically in response to user interaction. In step 203 access manager 25 (FIG. 1) automatically reads an Active Directory to identify network shared directories and downloads data indicating access groups (groups of users assigned rights to specific shared directories/folders) and shared directories access group owners, in response to a user initiating execution of an automated share/folder access application in access manager 25. Access manager 25 enables an administrator to specify which shared directories are displayed to each user or employee and automatically reads a database in repository 17 with employee information to obtain employee e-mail address, employee identifier, and network user identifier and phone extension, for example. In step 207, user interface 26 displays a web page to the user, which is automatically populated with data indicating available network shared directories and folders and prompts the user to select network shared directories from the list of available shared directories. The user verifies his contact information which is automatically loaded from a remote system and scrolls the image to view server names. In response to the user identifying a server that contains a directory, the user may click on a server representative icon to expand data indicating the server resources and see different shared directories that exist on the server. The user places a check in a check box adjacent to shared directories he desires access to and when finished with selection the user clicks the Submit button and is presented with a confirmation.

In step 211, user interface 26 displays a web page to the user which prompts the user to review current shared directories permissions and select any that are no longer needed to be relinquished. Access manager 25 deletes permission from the shared directories that the user selects to relinquish. User interface 26 also displays an image presenting data indicating to a shared directories owner, those employees with access to shared directories and prompts the owner to delete permissions of those employees no longer needing access. Access manager 25 deletes the selected employee identifiers from a group.

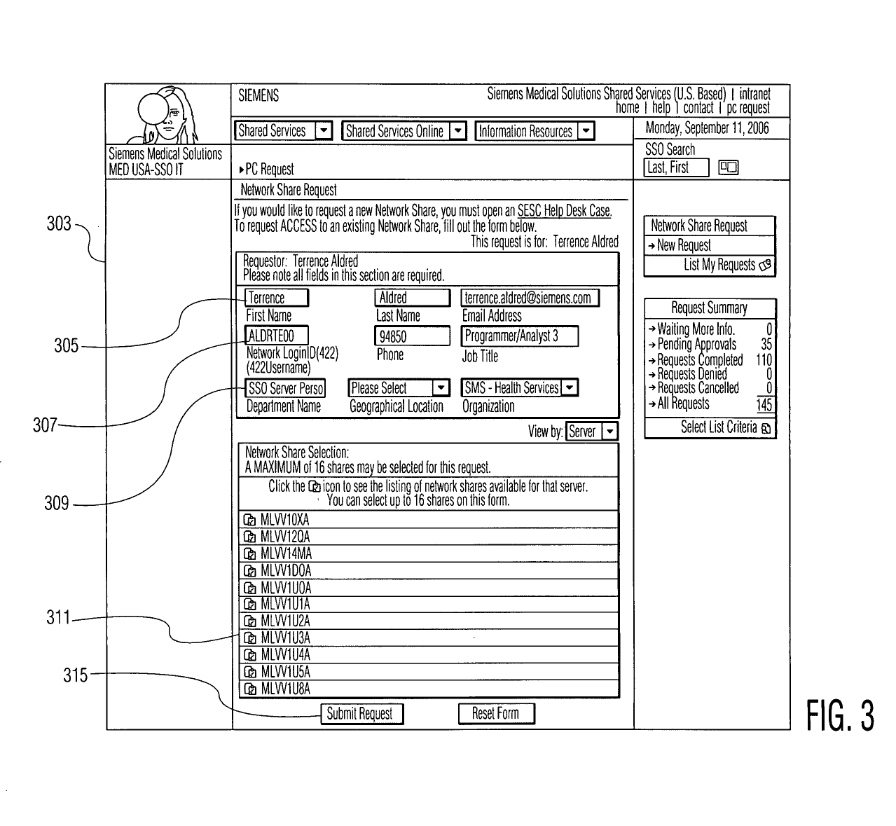

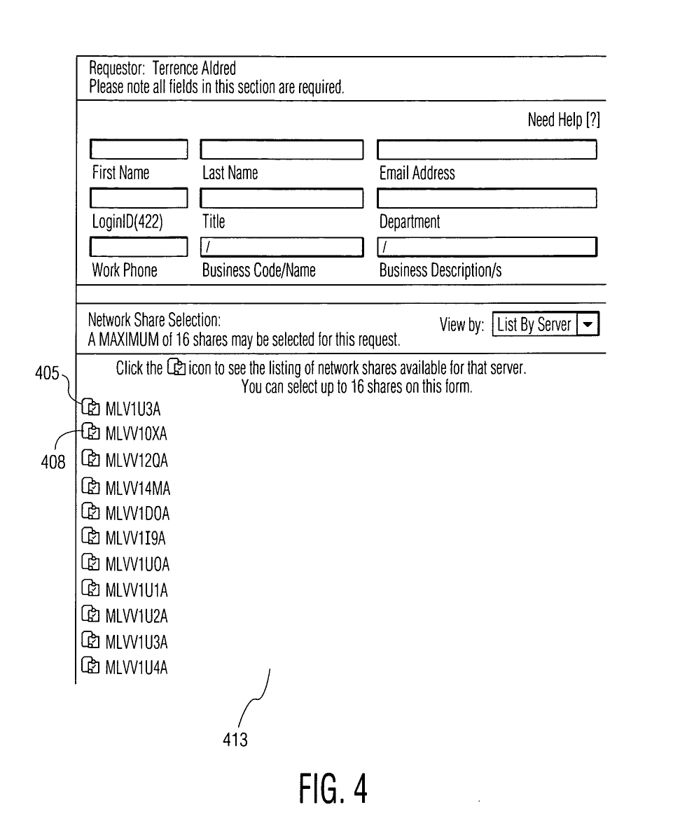

In step 213, a user selects one or more available shared directories or folders that it is desired to access via the web page presented on workstation 12. FIGS. 3 and 4 show user interface display image windows enabling a user to initiate a request for permission to access a processing system resource. Specifically, image window 303 of FIG. 3 is automatically populated with user specific information and enables a user with name identified in row 305, having identifier, phone no. and title indicated in row 307 and organization details indicated in row 309, to select one of multiple servers in window area 311. FIG. 4 illustrates a similar user interface display image window to the window of FIG. 3 but one that is not populated with user specific information.

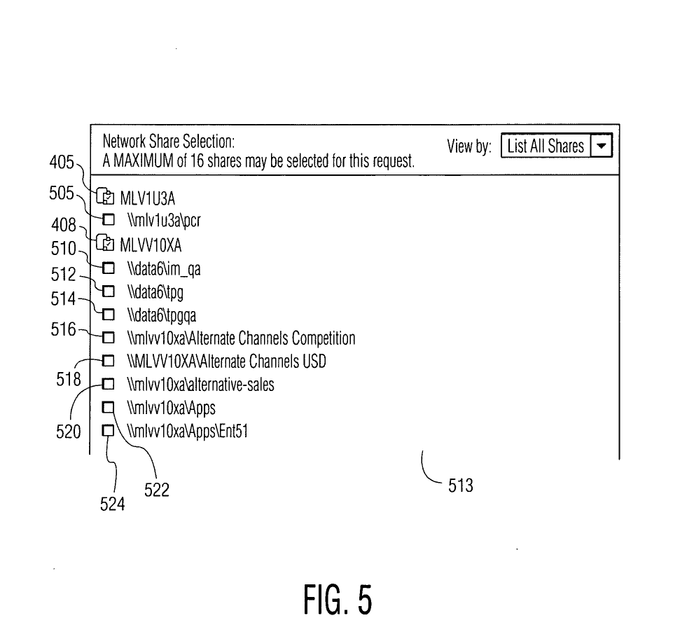

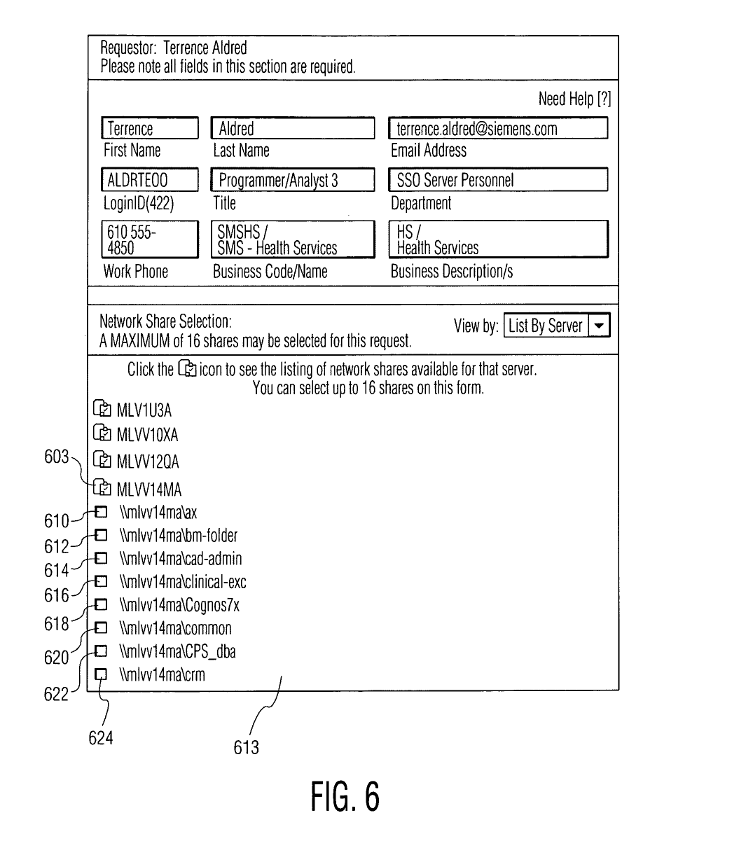

FIGS. 5 and 6 illustrate user interface display image windows enabling a user to select processing system resources to access that are available on one or more servers. Specifically, image window area 513 of FIG. 5 corresponds to image window area 413 of FIG. 4 following user selection of server representative items 405 and 408. Image window area 513 of FIG. 5 shows individually selectable directory or folder resources 505 of server 405 and 510, 512, 514, 516, 518, 522 and 524 of server 408. A user is able to select these individual directory and folder resources in window area 513 and to initiate a request for permission to access the selected resources. Image window area 613 of FIG. 6 similarly shows individually selectable directory or folder resources 610, 612, 614, 616, 618, 622 and 624 of server 603, that a user is able to select and to initiate a request for permission to access. A user initiates a request for permission to access selected directory, folder (or other processing system resources) by selection of a submit button, e.g. button 315 of FIG. 3.

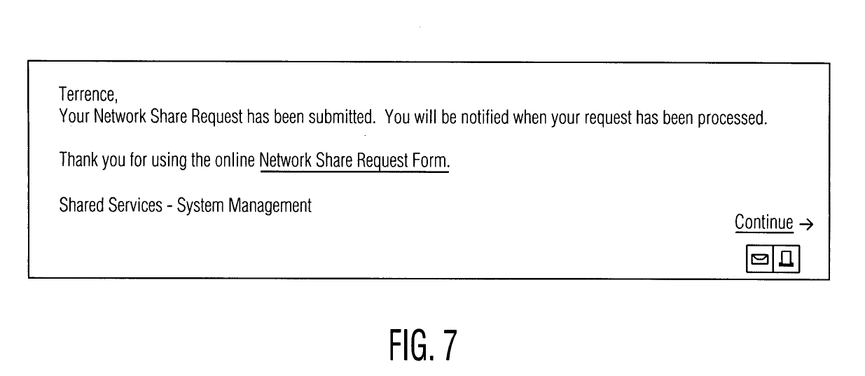

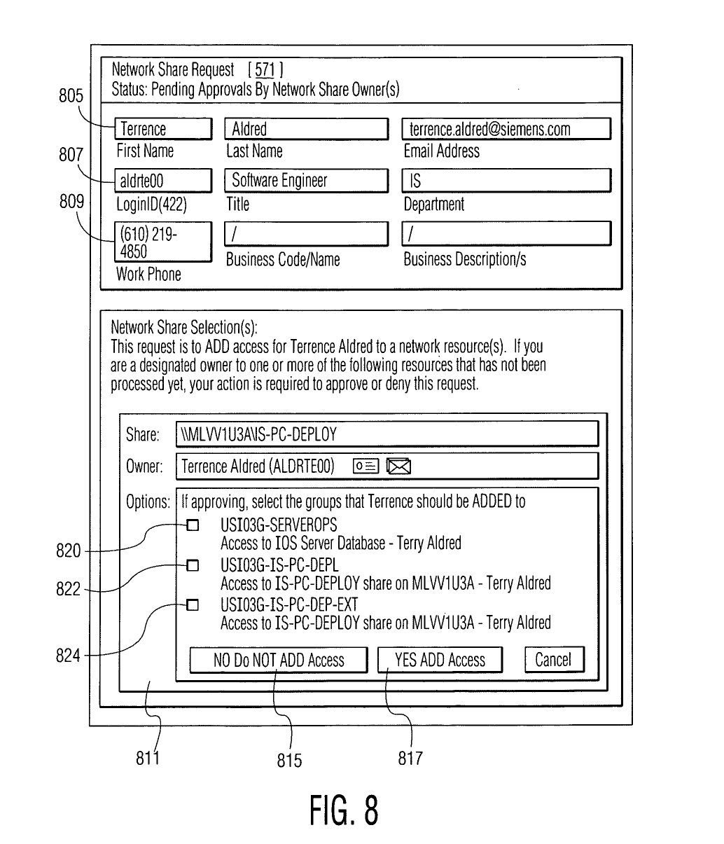

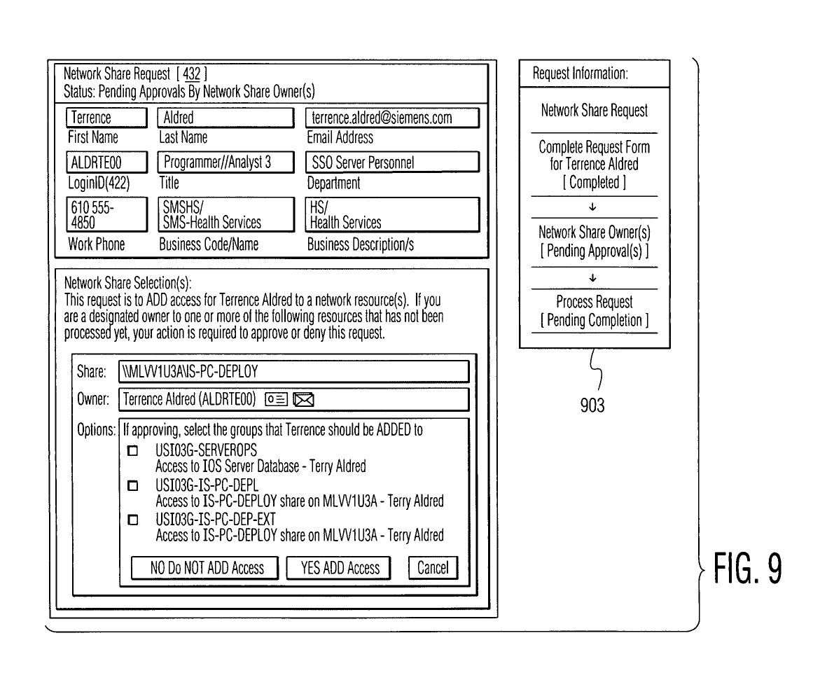

Communication processor 15, in step 217, automatically communicates an email message to a user indicating that a user request is pending. FIG. 7 illustrates a message communicated to a user indicating a request for access to a processing system resource is pending. Communication processor 15 also automatically communicates an email to the owner of the shared directories. The e-mail to the shared directories owner indicates that a request has been made for access to one or more of the owner managed shared directories or folders and prompts the owner for approval to allow the requesting user permission to access the shared directories or folders. The E-mail directs the owner to a specific website via which the owner enters data indicating approval or denial of the access permission request. FIGS. 8 and 9 show user interface display images enabling a recipient of a request for access to a processing system resource, i.e., the shared directories owner, to grant access.

Image window area 811 FIG. 8 prompts the shared directories owner to grant or deny access to individual resources to a requesting user having a name identified in row 805, having identifier, phone no. and title indicated in row 807 and organization details indicated in row 809. Specifically, image window area 811 prompts the shared directories owner to grant or deny access to individual shared directories identified in items 820, 822 and 824 by selecting (or not selecting) adjacent check boxes. Upon selection of individual shared directories identified in items 820, 822 and 824, a shared directories owner selects button 817 to confirm grant of access to the selected shared directories or denies access to any shared directories by selection of button 815.

FIG. 9 user interface display image is similar to the user interface image of FIG. 8 but additionally shows an access request status window area 903. Window area 903 identifies a network access request and completed access request forms. Window area 903 also indicates a network share owner has received an access request form and that access approval is pending and also identifies approved or denied access requests.

In response to an access request, a user enters data indicating approval or denial of the access permission request via the website in step 219. Access manager 25 automatically reads a response entered via the website and if denied, communication processor 15 automatically e-mails a denial message to the requesting user in step 227. If approved, access manager 25 in step 221 automatically adds the user to an authorizations list and appropriate directory or folder access group in an Active Directory giving the requesting user the requested access permission to the desired shared directories or folders (or other processing resource). In step 223, communication processor 15 automatically e-mails the requesting user an approval message and access permission specific information (e.g., server and pathway instructions).

System 10 manages user permissions to access network shared directories and other processing system resource without help-desk intervention. The system enables users to be added or deleted (automatically or in response to user command in another embodiment) from a list of users with permission to access particular network shared directories. A user selects a shared directory to which he desires access. System 10 sends an e-mail message to the shared directory managing owner, if the shared directory managing owner approves, the user is added to the authorization list governing access to the shared directory. Users are also automatically prompted to select shared directories they no longer need access to, and their rights on those shared directories are automatically relinquished. Thereby the system provides a user friendly interface supporting access request management, supports evaluation of individual access requests and prompts a user to select access permissions to shared directories that are no longer needed and are relinquished automatically by deletion of the user from the associated shared directory permissions list.

A user in need of access to a network shared directory logs into the access management web site and is shown what shared directories he already has access to and is prompted to relinquish access to shared directories. The user navigates to an access request section of the website and selects shared directories for which access is desired. The access requesting user and the shared directories owner are sent confirmation email messages. In response to processing the access request, system 10 emails the requesting user to indicate that the shared directories have been opened and the user may now map to, and access, the desired shared directories or alternatively informs the user that his request has been denied. System 10 and the website provide advantages to both users and administrators of company resources and network shared directories by automatically acquiring shared directory (and other resource) access information concerning a company network and by allowing the resource managing owners to organize how that information is viewed by the user on the website. In response to a user placing the cursor over each network directory (e.g., a hover action) displayed on the website display image, system 10 provides a pop up message indicating to the user what department uses the shared resource and the resources (printer, scanners, directories, or any other network resource) the user is able to access. The system automatically determines the email address of the user and what groups the user already has access to and lists them in the web page for the user to see. Once a request has been made and approved for user access to a certain resource or directory, the access is automatically granted or denied in one embodiment (without human intervention) and emails are automatically sent to the user with direction on how to use the resource. System 10 enables an administrator of network shared directories to manage resources by seeing who already has access to shared directories or other resources and gives the administrator the ability to add or remove people as desired. The administrator may organize the information on the website to suit a business process, either by server, department or resource, and dynamically grant or reject any request to access resources.

FIG. 10 shows a flowchart of a process performed by system 10 (FIG. 1) for automatically managing user permissions to access processing system resources. In step 912 following the start at step 911, user interface 26 (FIG. 1) provides data representing at least one display image that enables a user to view data indicating available processing system resources and enables a user to select a specific processing system resource and initiate (in one embodiment automatically) a request for permission to access the specific processing system resource. The at least one display image presents data prompting a user to relinquish permission to access a processing system resource and in one embodiment comprises a web site and one or more associated web pages. The at least one display image (e.g., the web site) shows available processing system resources categorized by at least one of, (a) server, (b) computer, (c) department, (d) organization and (e) device. The available processing system resources are provided by at least one of, a particular organization, a particular unit of the organization and a particular organization location. Also, the available processing system resources are resources available to, the user, multiple users of an organization and all users of an organization. In one embodiment, the at least one display image (e.g., presenting a web site) enables a user to view data indicating, processing system resources available to a plurality of users of an organization and in response to user command, processing system resources available to the user. The at least one display image shows data items individually representing multiple available processing system resources and in response to user command, an image area presents data indicating multiple available processing system resources associated with a particular user selected data item.

In step 917, communication processor 15, in response to detection of a user request for permission to access a particular processing system resource, automatically, acquires a user identifier and user email address, determines an owner responsible for granting permission to access the particular processing system resource and an associated owner email address, emails a request message to the owner email address to grant the access of the user to the particular processing system resource and receives a response email message indicating grant of the access. The owner in one embodiment comprises a worker responsible for managing access to processing system resources and in another embodiment comprises a (non-human) resource manager system responsible for automatically managing access to processing system resources. The request message to the owner email address includes a link to a web page enabling the owner to review and approve a request to grant access to processing system resources. In response to the communication processor receiving a response email message indicating denial of the access, access manager 25 inhibits update of the access data to enable the user to access the particular processing system resource and communication processor 15 automatically emails a message to the user indicating access is denied and identifying the owner. Access manager 25, in step 919 in response to the received grant of the access, updates access data to enable the user to access the particular processing system resource. The process of FIG. 10 terminates at step 825.

The systems and processes of FIGS. 1-10 are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. The system is not limited to healthcare and is advantageously applicable to any business with multiple shared directories and users. The system advantageously provides automatic permission ascertainment, automatic addition of a user to a shared directories access list and automatic e-mail generation upon completion of grant of access. The processes and applications may in alternative embodiments, be located on one or more (e.g., distributed) processing devices accessing a network linking the elements of FIG. 1. Further, any of the functions and steps provided in FIGS. 1-10 may be implemented in hardware, software or a combination of both and may reside on one or more processing devices located at any location of a network linking the elements of FIG. 1 or another linked network including the Internet.

What is claimed is:

1. A system for automatically managing user permissions to access processing system resources, comprising:
a user interface providing data representing at least one display image enabling a user to request permission to access a particular processing system resource;
a communication processor for, in response to detection of a user request for permission to access a particular processing system resource, automatically,
acquiring data comprising a user identifier and user email address,
determining an owner responsible for granting permission to access said particular processing system resource and an associated owner email address,
emailing a request message to said owner email address to grant said access of said user to said particular processing system resource and
receiving a response email message indicating grant of said access;
an access manager for, in response to a received grant of said access, updating access data to enable said user to access said particular processing system resource.

2. A system according to claim 1, wherein
in response to said communication processor receiving a response email message indicating denial of said access, said access manager inhibits update of said access data to enable said user to access said particular processing system resource and said communication processor automatically emails a message to said user indicating access is denied and identifying said owner.

3. A system according to claim 1, wherein
said at least one display image presents a web site enabling a user to view data indicating available processing system resources and enabling a user to select a specific processing system resource and automatically initiate a request for permission to access said specific processing system resource.

4. A system according to claim 3, wherein
said at least one display image presenting said web site shows available processing system resources categorized by at least one of, (a) server, (b) computer, (c) department, (d) organization and (e) device.

5. A system according to claim 3, wherein
said available processing system resources are provided by at least one of, (a) a particular organization, (b) a particular unit of said organization and (d) a particular organization location.

6. A system according to claim 3, wherein
said available processing system resources are resources available to, (a) said user, (b) a plurality of users of an organization and (c) all users of an organization.

7. A system according to claim 3, wherein
said at least one display image presents a web site enabling a user to view data indicating,
processing system resources available to a plurality of users of an organization and
in response to user command, processing system resources available to said user.

8. A system according to claim 3, wherein
said at least one display image presenting said web site shows data items individually representing a plurality of available processing system resources and in response to user command an image area presents data indicating a plurality of available processing system resources associated with a particular user selected data item.

9. A system according to claim 1, wherein
said at least one display image presents data prompting a user to relinquish permission to access a processing system resource.

10. A system according to claim 1, wherein
said at least one display image enables a user to view data indicating available processing system resources and enables a user to select a specific processing system resource and automatically initiate a request for permission to access said specific processing system resource.

11. A system according to claim 1, wherein
said owner comprises a worker responsible for managing access to processing system resources.

12. A system according to claim 1, wherein
said owner comprises a resource manager system responsible for automatically managing access to processing system resources.

13. A system for automatically managing user permissions to access processing system resources, comprising:
a user interface providing data representing at least one display image enabling a user to view data indicating available processing system resources and enabling a user to select a specific processing system resource and automatically initiate a request for permission to access said specific processing system resource;
a communication processor for, in response to detection of a user request for permission to access a particular processing system resource, automatically,
acquiring data comprising a user identifier and user email address,
determining an owner responsible for granting permission to access said particular processing system resource and an associated owner email address,
emailing a request message to said owner email address to grant said access of said user to said particular processing system resource and
receiving a response email message indicating grant of said access;
an access manager for, in response to said received grant of said access, updating access data to enable said user to access said particular processing system resource.

14. A system according to claim 13, wherein
said at least one display image presents a web site.

15. A system according to claim 13, wherein
said request message to said owner email address includes a link to a web page enabling said owner to review and approve a request to grant access to processing system resources.

16. A system for automatically managing user permissions to access processing system resources, comprising:
a user interface providing data representing at least one display image enabling a user to request permission to access a particular processing system resource;
a communication processor for, in response to detection of a user request for permission to access a particular processing system resource, automatically,
acquiring data comprising a user identifier and user email address,
determining a resource manager system responsible for granting permission to access said particular processing system resource and an associated owner communication address,
communicating a request message to said resource manager system address to grant said access of said user to said particular processing system resource and
receiving a response message indicating grant of said access;
an access manager for, in response to a received grant of said access, updating access data to enable said user to access said particular processing system resource.
